(19) United States
(12) Patent Application Publication
(10) Pub. No.: US 2004/0031825 A1
(43) Pub. Date: Feb. 19, 2004

(54) Garment hanger

(76) Inventor: James Edward Roberts, Nantwich (GB)

Correspondence Address: ALIX YALE & RISTAS LLP, 750 MAIN STREET, SUITE 1400, HARTFORD, CT, 06103, US

(21) Appl. No.: 10/312,825

(22) PCT Filed: Jun. 29, 2001
(86) PCT No.: PCT/GB01/02884

(30) Foreign Application Priority Data
Jun. 29, 2000 (GB) 0015945.9

(51) Int. Cl. A41D 27/22; B23C 1/00

(52) U.S. Cl. 223/85; 409/172

(57) ABSTRACT

This invention relates to a garment hanger comprising two parts or elements (2, 2′) which are hinged together so that they can be folded from a first relatively flat or opened out configuration to a second configuration in which the two parts or elements are adjacent and facing each other, at least one of the parts including first means (11) by which the hanger can depend from a support when in its second configuration, the two parts providing second means (12) from which a garment can be hung. The two parts or elements are preferably of a flexible stiff sheet material such as a corrugated material, e.g. corrugated cardboard.

This invention relates to a clothes hanger.

Clothes hangers are widely used in domestic and retail environments. They are generally to be produced from either metal or plastic and consequently are prone to either bending or snapping. Wire hangers can misshape clothing, and most end up accumulating in wardrobes and are rarely suitably disposed of.

The present invention is aimed at both the retail and domestic markets and provides, at least in preferred embodiments, a low cost and more environmentally friendly alternative, capable of carrying one or more items of clothing or clothing accessories such as shirts, jackets, ties, skirts and trousers. Once the hanger has served its purpose, it can be easily disposed of and recycled.

In accordance with one aspect of the present invention there is provided a garment hanger comprising two parts or elements which are hinged together so that they can be folded from a first relatively flat or opened out configuration to a second configuration in which the two parts or elements are adjacent and facing each other, at least one of the parts including first means by which the hanger can depend from a support when in its second configuration, the two parts providing second means from which a garment can be hung.

The two parts or elements are preferably of a flexible stiff sheet material such as a corrugated material, e.g. corrugated cardboard.

The corrugations or flutes of one part or element are preferably transverse or slanted relative to the corrugations or flutes of the other part. Preferably the corrugations or flutes of one part are at an angle of 60 to 120°, more preferably 80 to 100°, relative to the corrugations or flutes of the other part. To this end the corrugations or flutes are preferably at an angle of 30 to 60°, more preferably 40 to 50°, relative to at least one fold line along which the two parts are hinged together.

Embodiments of the present invention are described below by way of example with reference to the accompanying drawings, in which:

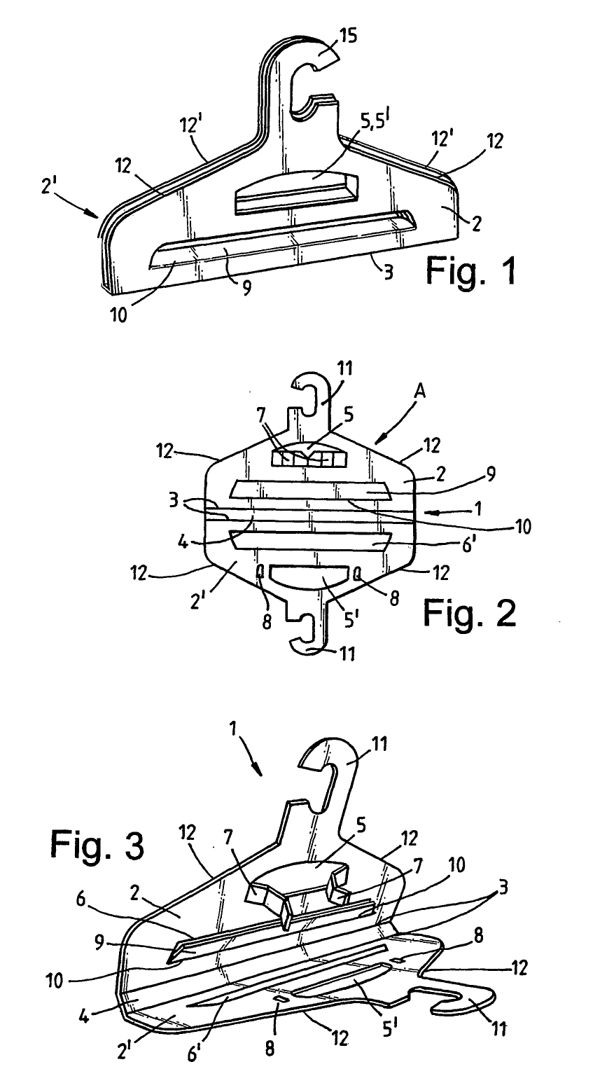

FIG. 1 shows, in perspective, a first hanger according to the invention, fully assembled;

FIG. 2 shows, fully opened out, a blank from which the first hanger is formed or assembled;

FIG. 3 shows the first hanger partially assembled;

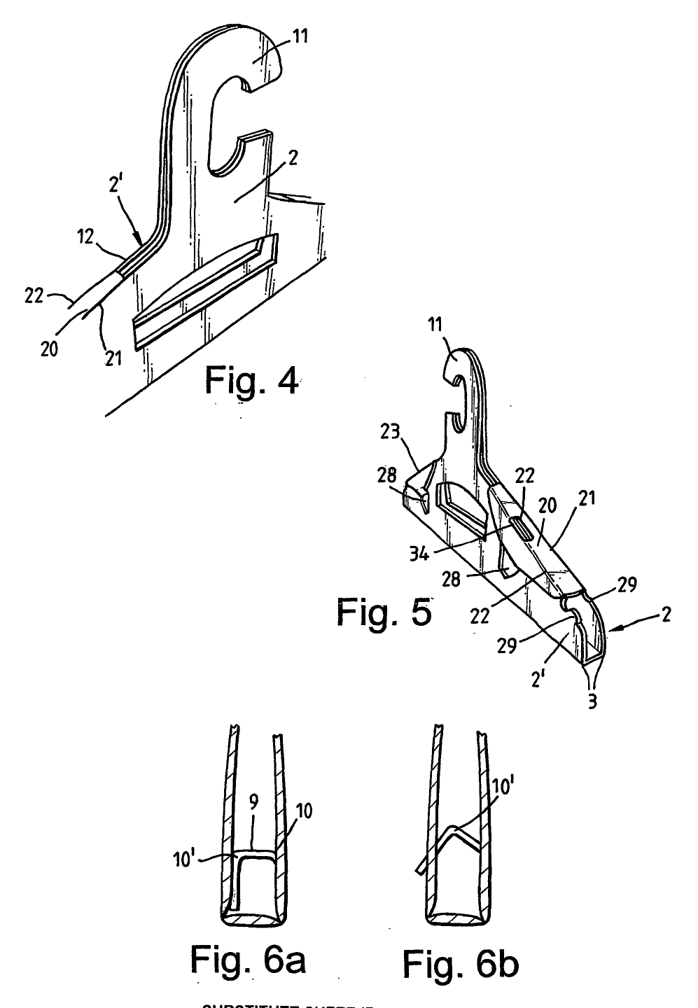

FIG. 4 shows, in perspective, a detail of a second hanger according to the invention;

FIG. 5 shows, in perspective, the second hanger;

FIGS. 6A and 6B show two cross-sectional views of alternative ways the trouser shelf of the first or second hanger may be disposed or arranged;

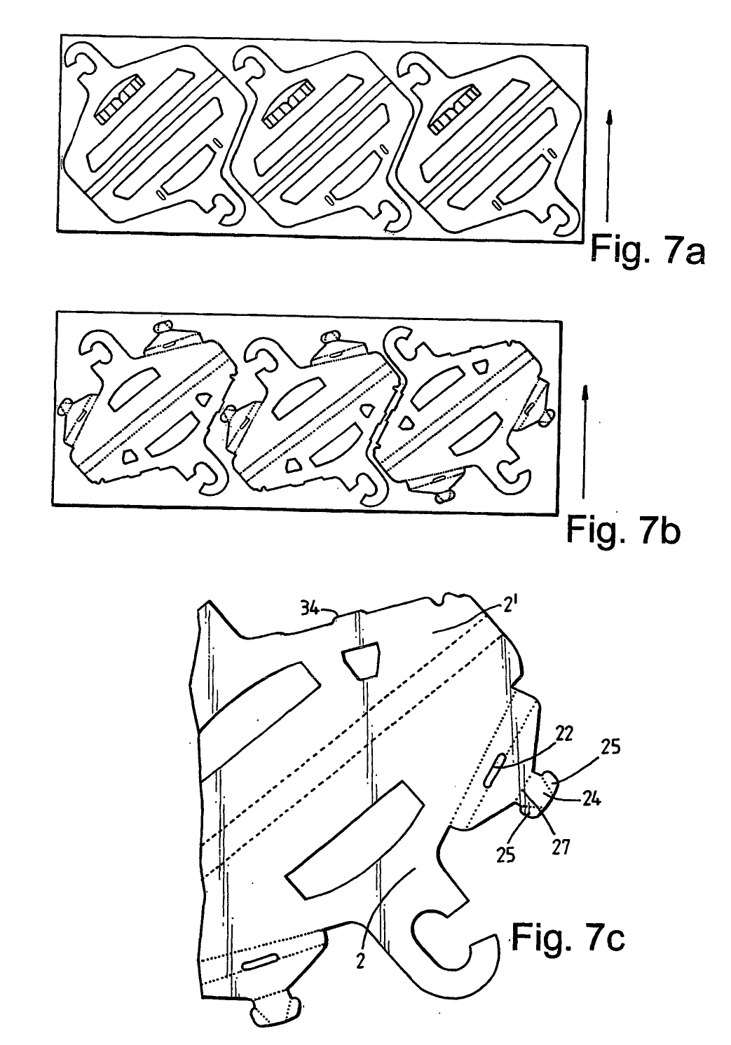

FIGS. 7A and 7B shows the manner in which blanks to form the first and second hangers respectively may be tessellated on a sheet of material (corrugated cardboard) from which they are to be cut; and

FIG. 7C shows a detail of FIG. 7.

Referring to FIGS. 1 to 3 of the drawings, the first hanger is formed or assembled from a blank 1 (FIG. 2) die cut from a sheet of corrugated cardboard. The corrugated cardboard is either virgin or recycled 4 mm thick corrugated cardboard (having planar surfaces i.e. two spaced planar outer sheets connected by an intermediate corrugated sheet) with the corrugations or corrugate flute running diagonally across the hanger in the direction of arrow A in FIG. 2 (and FIG. 7).

FIG. 2 shows the blank fully opened in its flat state. The blank comprises two matching (except as described below) parts or elements 2 and 2′ defined by a pair of mutually parallel fold lines 3, a strip 4 being defined between the fold lines 3. The corrugate flute is at 45° to the fold lines 3.

The parts 2 and 2′ are formed with like short, upper apertures 5 and 5′, respectively, and like long, apertures 6 and 6′ respectively, each aperture being closed at its ends.

The part 2 includes two tabs or fingers 7 connected to the remainder of the part along fold lines at the ends of the aperture 5, these fold lines being at right angles to the fold lines 3. Each tab 7 also has a pair of fold lines intermediate its end connected to the remainder of the part 2 at one end of the aperture 5 and its free end, these fold lines also being at right angles to the fold lines 3.

Rectangular holes or slots 8 are cut into the part 2′ adjacent but spaced from the ends of the aperture 5′, to leave small flags hinged to the remainder of the part 2′ in the lengthwise direction of the slot.

The part 2 further includes a flap 9 extending the length of the aperture 6 and connected to the remainder of the part 3 along a fold line 10 parallel to the fold lines 3.

Each part has a hook formation 11 remote from the fold lines 3. The upper edge 12 of each part 2 and 2′ slopes away from the hook formation 11.

To assemble the hanger the two parts 2 and 2′ are folded towards each other about the fold lines 3 to form a narrow channel between the parts 2 and 2′ and the strip 4. The tabs 7 are fed through the aperture 5′ and folded and inserted into the holes 8 of the part 2′ to lock the two parts 2, 2′ together to form the hanger, as shown in FIG. 1. The small flaps at the slots 8 assist in retaining the tabs 7 in the holes 8. The two hook formations 11 are in contact with each other and in alignment with each other to form a hook 15.

The flap 9 (not shown in FIG. 1) is folded down along the fold line 10 to rest upon the lower edge of the aperture 6 of the part 2′. (See below description relating to FIGS. 6A and 6B).

The adjacent pairs of edges 12 form shoulders 12′.

A jacket or skirt can be hung upon the hanger, supported by the shoulders 12′. Clothing accessories such as ties and belts can be passed through the apertures 5 and hung from the hanger.

The legs of a pair of trousers may be passed through the apertures 6, 6′ and thereby hung from the hanger. The flap 9 acts as a shelf to mitigate creasing of the trouser legs transversely of the legs and (when the flap is folded as shown in FIG. 6B, as described below) its longitudinal free edge acts as a brake to inhibit the trousers slipping off the hanger.

The edges 12 of one part 2 are slightly spaced from the edges 12 of the other part 2′ (see FIG. 1) thereby to increase the width of the shoulders 12′ to mitigate misshaping of garments such as a jacket hung on the hanger. The stiffness of the hanger is enhanced by the fact that the blank is bent about the fold lines 3. The corrugated flutes of one part 2, 2′ are at 90° to the corrugate flute of the other part 2, 2′ in the assembled hanger whereby the stiffness of the assembled hanger is considerably further enhanced: bending of the hanger out of the plane of either part 2, 2′ is difficult.

The hanger can be suspended from a rail in a wardrobe by the hook formation 15.

To open out the hanger, the assembly steps described above are simply reversed.

Text and graphics may be printed or written on the blank so as to be visible in the assembled hanger.

The fact that the hanger is made of a single piece of cardboard minimises production and assembly costs.

Alternative means of securing one part 2, 2′ to the other part 2, 2′ may be used. One such means comprises provision of a tab of one part and a slot through the other part, the head of the tab being provided with barbs so that when pushed through the slot it cannot readily be withdrawn.

Instead of the use of tabs to fasten the two parts together, glue may be used. The blank and other like blanks may be cut from a single sheet of corrugated cardboard, the arrangement of the blanks being such as to minimise waste of the sheet material.

Notches may be provided towards the ends of the shoulders for waist loops of a skirt or straps of a dress to be hung from the hanger (as with the second hanger, described below).

One hook formation 11 alone may suffice to provide a satisfactory hook. I.e. only the part 2 or 2′ need have a hook formation 11. However, with only one hook formation the hook would be more likely to be inadvertently bent.

Referring to FIGS. 4, 5, 7B and 7C of the drawings, the second hanger is, except as described below, similar to the first hanger and like reference numerals are used to indicate like parts. Assembly of the second hanger from the blank is likewise similar to that of the first hanger.

In the second hanger, the part 2 is formed with flaps 20 along its edges 12, the flaps 20 being connected to the remainder of the part 2 at fold lines 21 along the edges 12.

The flaps 20 are formed with slots 22. Each flap 20 also has a fold line 23 parallel to the fold line 21 and running adjacent the edge of the slot 22 remote from the fold line 21.

Each flap 20 terminates, remotely from the fold line 23, in a tab or flap 24 (see FIG. 7B) itself formed with two lateral subsidiary tabs or flaps 25. The tab 24 is connected to the remainder of the flap 20 along a fold line 27 parallel to the fold lines 21 and 23 and the tabs 25 as connected to the remainder of the tab 24 along fold lines at about 50° to the fold line 27.

The part 2′ is formed with tabs or projections 34 on its edges 12, each tab extending from the edge 12 by a distance equal to (or slightly less than) the thickness of the cardboard from which the blank is cut. The tabs 34 are not hinged relative to the remainder of the part 2′ i.e. they are substantially rigidly connected to the remainder of the part 2′.

The part 2′ is also formed with apertures 28.

Notches 29 are provided toward the outer ends of the edge 12 for waist loops of a skirt or straps of a dress to be hung from the hanger.

The second hanger does not have the tabs 7 and apertures 8 of the first hanger.

To assemble the second hanger, after the two parts have been folded towards each other along the fold lines 3 to form the narrow channel, the flaps 20 are folded about the fold lines 21 across the edges 12 of the part 2′ and the tabs 34 are each inserted into a respective one of the slots 22, from which they do not protrude. The flaps 20 are then folded down along the fold lines 23 to lie adjacent the part 2′.

As this is done, the tabs 24 are inserted into the apertures 28. This necessitates folding the subsidiary tabs 25 to allow the tabs 24 to enter the apertures 28. The tabs 24 are then opened out between the parts 2 and 2′ to lock the hanger into its assembled state.

The flaps 20 provide a shoulder over the parts 2 and 2′ protecting a jacket or shirt hung on the hanger from abrasion and creasing.

The flap 9 of the first or second hanger may be folded down along the fold line 10 and further folded along a fold line 10′ parallel to the fold line 10 so as to lie entirely between the parts 2 and 2′ whereby to create a box section (as shown in FIG. 6A) which increases the strength and lateral stiffness of the hanger.

Alternatively the flap may be folded along the fold line 10′ but left (as shown in FIG. 6B) with its free edge portion protruding through the aperture 6′ of the part 2′ so that its free edge can act as a brake to inhibit trousers slipping off the hanger as described above.

The shapes of the blanks of the first and second hanger lend themselves to being disposed in a tessellated arrangement of the material from which the blanks can cut, thereby minimising wastage of the material.

FIGS. 7A, 7B and 7C respectively show such tessellated arrangements of the blanks to form first and second hangers as described above.

1. A garment hanger comprising two parts or elements which are hinged together so that they can be folded from a first relatively flat or opened out configuration to a second configuration in which the two parts or elements are adjacent and facing each other, at least one of the parts or elements including first means by which the hanger can depend from a support when in its second configuration, the two parts providing second means from which a garment can be hung.

2. A hanger according to claim 1, wherein the two parts are hinged together along at least one fold line.

3. A hanger according to claim 2, wherein the two parts are hinged together along two parallel fold lines.

4. A hanger according to claim 2 or 3, wherein the first means is remote from the at least one fold line.

5. A hanger according to any preceding claim, wherein the first means is in the form of a hook.

6. A hanger according to any preceding claim, wherein the second means comprises shoulders at upper edges of the hanger when in its second configuration, whereby a shirt or jacket can be hung on the hanger.

7. A hanger according to any preceding claim, wherein the second means comprises a trouser shelf.

8. A hanger according to claim 7, wherein the trouser shelf comprises flap hingedly connected to one of said parts.

9. A hanger according to claim 8, wherein the flap can rest upon an edge of the other part when the hanger is in its second configuration to act as a trouser brake.

10. A hanger according to any of claims 7 to 9, wherein the trouser shelf is at the upper edges of apertures, each in a respective one of the parts and which are aligned with each other when the hanger is in its second configuration and which are closed at their ends.

11. A hanger according to any preceding claim, further including means from which one or more clothing accessories can be hung.

12. A hanger according to any preceding claim, further comprising means for securing the two parts together to maintain them in their second configuration.

13. A hanger according to claim 12, wherein the means comprises at least one tab on one part and engageable with the other part.

14. A hanger according to any preceding claim, formed of cardboard.

15. A hanger according to any preceding claim, formed of corrugated sheet material.

16. A hanger according to claim 15, wherein when the hanger is in its second configuration the corrugations or flutes in one said part or element are transverse to the corrugations or flutes of the other part or element.

17. A hanger according to claim 16, wherein the corrugations or flutes of the each part are at an angle in the range of 30 to 60° relative to the at least one fold line.

18. A garment hanger formed by cutting from a sheet of material and including first means by which the hanger can depend from a support and second means from which a garment can be hung.

19. A garment hanger comprising two parts formed of corrugated sheet material one which can be arranged adjacent and having each other with the corrugations or flutes of one part being transverse to or slanted relative to the corrugations or flutes of the other parts, at least one of the parts including first means by which the hanger can depend from a support and at least one of the parts providing second means from which a garment can be hung.

20. A hanger according to claim 18 or 19 and further in accordance with any of claims 1 to 14.

21. A garment hanger substantially as herein described with reference to and as illustrated in the accompanying drawings.
